(19) United States
(12) Patent Application Publication
(10) Pub. No.: US 2022/0284741 A1
(43) Pub. Date: Sep. 8, 2022

(54) INFORMATION PROCESSING DEVICE, INFORMATION PROCESSING METHOD, AND PROGRAM

(71) Applicant: TOYOTA JIDOSHA KABUSHIKI KAISHA, Toyota-shi (JP)

(72) Inventor: Hisanori SHIBA, Toyota-shi (JP)

(73) Assignee: TOYOTA JIDOSHA KABUSHIKI KAISHA, Toyota-shi (JP)

(21) Appl. No.: 17/564,894

(22) Filed: Dec. 29, 2021

(30) Foreign Application Priority Data
Mar. 4, 2021 (JP) 2021-034829

(51) Int. Cl. G07C 5/00; G07C 5/08

(52) U.S. Cl. CPC G07C 5/008; G07C 5/0841; G07C 5/0808

(57) ABSTRACT

An information processing device that communicates with one or more electronic control units of a vehicle. The information processing device identifies an electronic control unit performing an abnormal operation based on messages sent or received by the one or more electronic control units and acquires snapshots data representing the current operating state of the identified electronic control unit.

### CROSS-REFERENCE TO RELATED APPLICATION

This application claims priority to Japanese Patent Application No. 2021-034829 filed on Mar. 4, 2021, incorporated herein by reference in its entirety.

### BACKGROUND

### 1. Technical Field

The present disclosure relates to an information processing device, an information processing method, and a program.

### 2. Description of Related Art

In recent years, automobiles have become more and more electronically controlled. In connection with this technique, Japanese Unexamined Patent Application Publication No. 2016-129314 (JP 2016-129314 A) discloses an in-vehicle network system for detecting that one of a plurality of electronic control units of a vehicle has sent an abnormal message.

### SUMMARY

The present disclosure provides an information processing device, an information processing method, and a program for efficiently collecting information about an electronic control unit in which an abnormality has occurred.

A first aspect of the present disclosure relates to an information processing device that communicates with one or more electronic control units of a vehicle. More specifically, the information processing device includes a control unit. The control unit is configured to identify an electronic control unit performing an abnormal operation based on messages sent or received by the one or more electronic control units and to acquire snapshot data representing the current operating state of the identified electronic control unit.

A second aspect of the present disclosure relates to an information processing method performed by an information processing device that communicates with one or more electronic control units of a vehicle. More specifically, the information processing method includes identifying an electronic control unit performing an abnormal operation based on messages sent or received by the one or more electronic control units and acquiring snapshot data representing the current operating state of the identified electronic control unit.

Other aspects of the present disclosure include a program causing a computer to execute the above-described information processing method or a computer readable storage medium on which the program is stored in a non-transitory manner.

According to the present disclosure, it is possible to efficiently collect information about an electronic control unit in which an abnormality has occurred.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a system configuration diagram of a vehicle system according to an embodiment;

FIG. 2 is a block diagram showing the components included in a vehicle;

FIG. 3 is a block diagram showing a configuration of a microcomputer included in a gateway;

FIG. 4A is a diagram showing an example of data stored in a message DB;

FIG. 4B is a diagram showing an example of data stored in a snapshot DB;

FIG. 5 is a block diagram showing the components included in a center server;

FIG. 6 is a flowchart of first processing performed by the gateway;

FIG. 7 is a flowchart of data sent and received between the components; and

FIG. 8 is a flowchart of second processing performed by the gateway.

### DETAILED DESCRIPTION OF EMBODIMENTS

One aspect of the present disclosure is an information processing device that communicates with one or more electronic control units of a vehicle. More specifically, the information processing device includes a control unit configured to identify an electronic control unit performing an abnormal operation, based on messages sent or received by the one or more electronic control units, and to acquire snapshot data representing the current operating state of the identified electronic control unit.

The information processing device is, for example, a computer connected to an in-vehicle network. The information processing device has the function to identify an electronic control unit that is included in a vehicle and is performing an abnormal operation, that is, an unexpected operation.

There is known a technique that identifies an electronic control unit that is among a plurality of electronic control units included in a vehicle and is performing an abnormal operation. The electronic control unit that is performing an abnormal operation can be identified, for example, based on the messages sent by the electronic control units.

However, it may sometimes be difficult to determine the specific cause of an abnormality only by investigating the messages sent and received by the electronic control units. In addition, since the state of an electronic control unit changes from moment to moment, the acquisition of data, if performed for identifying an abnormality (for example, debugging), may be too late.

To address this problem, the information processing device according to the present disclosure identifies an electronic control unit that is operating abnormally and, at the same time, acquires snapshot data for the identified electronic control unit. The snapshot data, the data representing the current state of the electronic control unit, is typically a memory dump or the like. The information processing device performs these two types of processing at the same time in this way, making it possible to leave data that indicates the state of the electronic control unit at the time when the abnormality is recognized. This is also useful for investigating the cause of the abnormality occurrence.

The information processing device may further include a storage unit configured to store messages sent or received by the one or more electronic control units in the past. The control unit may also be configured to identify the electronic control unit performing the abnormal operation based on the stored messages. By storing the messages sent and received by the electronic control units in the past, the electronic control unit that caused the abnormality can be retroactively investigated.

The control unit may be configured to relay messages exchanged by two or more of the electronic control units and to store the relayed messages. The information processing device may also serve as a device (gateway) that relays messages exchanged by the electronic control units. By storing the messages flowing through the in-vehicle network, the state of the electronic control units can be appropriately monitored.

The control unit may be configured to start identifying the electronic control unit performing the abnormal operation when it is detected that an abnormality has occurred in any one of the one or more electronic control units. The control unit may be configured to notify a user when it is detected that an abnormality has occurred in any one of the one or more electronic control units and, based on an instruction from the user, to start identifying the electronic control unit performing the abnormal operation.

Instead of monitoring all messages, the control unit may be configured to start identifying the electronic control unit causing the abnormality at a time when a predicted trigger occurs. For example, when some event that cannot normally occur in the system is observed, the control unit starts identifying the electronic control unit causing the abnormality. Such a configuration makes it possible to identify the abnormality at low cost.

The control unit may be configured to detect that an abnormality has occurred in one of the one or more electronic control units, based on a dark current flowing through the one or more electronic control units. The dark current is a current flowing through the electronic control units when the vehicle system is stopped. When the dark current value exceeds a predetermined value, it is presumed that one of the electronic control units of the vehicle is operating abnormally.

The control unit may be configured to send the acquired snapshot data to a server device that manages the vehicle. Such a configuration makes it possible to speedily share data for investigating the cause of the abnormality.

The control unit may be configured to send a reset signal to the one or more electronic control units after acquiring the snapshot data. After acquiring the necessary information, an emergency procedure can be performed by resetting the electronic control unit in which an abnormality has occurred.

An embodiment of the present disclosure will be described below with reference to the drawings. It should be noted that the configuration of the embodiment in the description below is an example only and that the present disclosure is not limited to the configuration of the embodiment.

### First Embodiment

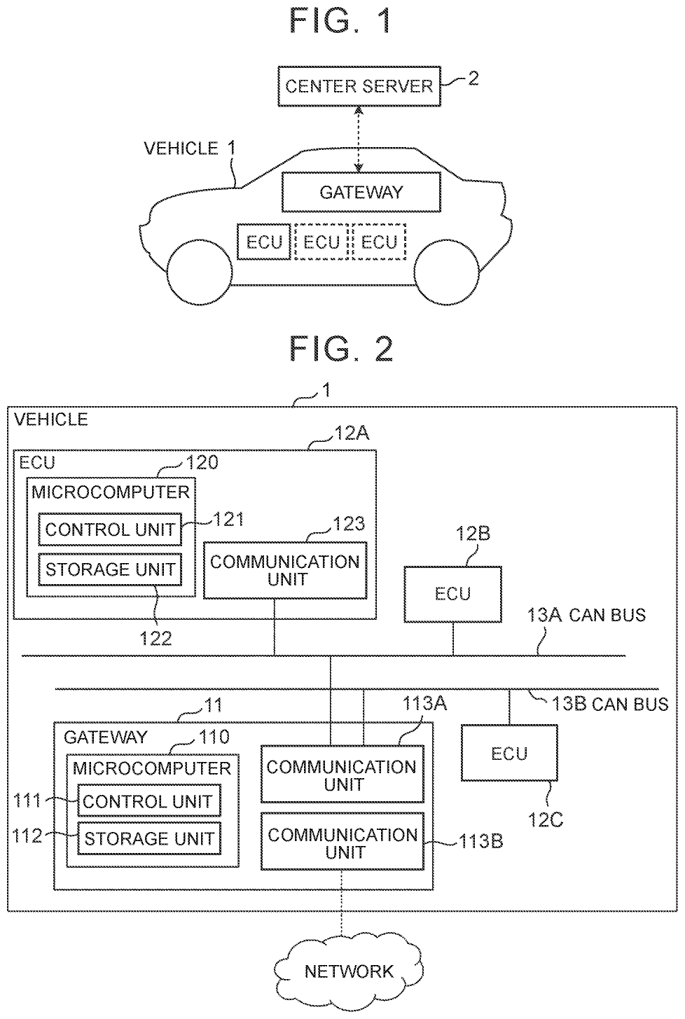

The outline of a vehicle system according to a first embodiment will be described with reference to FIG. 1. The vehicle system according to this embodiment includes a vehicle 1 and a center server 2.

The vehicle 1 is a connected car having the communication function. The vehicle 1 includes a plurality of electronic control units (also called ECU) and a gateway that is a computer for managing the electronic control units. The gateway has two functions: communication mediation function and data collection function. The communication mediation function mediates communication between the inside and outside of the host vehicle. The data collection function monitors the operation of the ECUs of the host vehicle and, when an abnormal operation occurs in any of the ECUs, collects data for identifying the abnormality. An abnormal operation that occurs in an ECU refers to an operation that is not expected during the design stage of the ECU. For example, it is determined that an abnormal operation has occurred when the ECU is operating at a time when it should not operate or when a message that should not be sent or received is sent or received.

The center server 2 is a server device that manages the vehicle 1. The center server 2 may manage a plurality of vehicles 1. The center server 2 wirelessly communicates with the vehicle 1 to collect various type of data. In this embodiment, when an abnormal operation occurs in any of the ECUs of the vehicle 1, the center server 2 collects data for identifying the abnormality in response to a report from the vehicle 1.

The components of the system will be described more in detail. FIG. 2 is a block diagram schematically showing an example of the hardware configuration of the vehicle 1 shown in FIG. 1. The vehicle 1 includes a gateway 11 and a plurality of ECUs (ECU 12A, ECU 12B, ECU 12C, . . . ). Examples of the ECUs in the vehicle include an engine ECU, a body ECU, a power train ECU, or a hybrid ECU. Although the plurality of ECUs is illustrated in FIG. 2, these ECUs are collectively referred to as an ECU 12 when it is not necessary to distinguish them from each other.

These components are connected to each other by a bus (CAN bus) of the in-vehicle network. In this embodiment, the vehicle 1 includes a plurality of communication buses (CAN buses 13A and 13B), and each of the ECUs is connected to one of these communication buses. The ECUs connected in this way send and receive data to and from each other via the CAN buses. Although the plurality of CAN buses is illustrated in FIG. 2, these CAN buses are collectively referred to as a CAN bus 13 when it is not necessary to distinguish them from each other.

The gateway 11 functions as a relay device for relaying data between the ECUs. The gateway 11 also functions as a device that connects the vehicle 1 to an external network. Through the gateway 11, each of the ECUs in the vehicle 1 can communicate with a different in-vehicle network and with a network outside the vehicle. In the description below, a network outside the vehicle 1 is simply referred to as a network or an external network. Examples of external networks include a wide area network such as the Internet.

The gateway 11 includes a microcomputer 110, a communication unit 113A that is an interface for communicating with a plurality of CAN buses, and a communication unit 113B that is an interface for communicating with an external network.

The microcomputer 110 can be configured as a microcomputer having a processor such as a central processing unit (CPU) or a graphics processing unit (GPU), a main storage device such as a RAM or a ROM, and an auxiliary storage device such as an EPROM, a disk drive, or a removable media. It should be noted that some or all of the functions may be implemented by hardware circuits such as an ASIC or an FPGA.

In this embodiment, the microcomputer 110 includes a control unit 111 and a storage unit 112. The control unit 111 is an arithmetic unit that executes predetermined programs for implementing various functions of the gateway 11. The storage unit 112 is a memory device including a main storage device and an auxiliary storage device. The auxiliary storage device stores the operating system (OS), various programs, various tables, etc. Programs stored in the auxiliary storage device are loaded into the main storage device for execution to implement the functions, which will be described later, that meet the predetermined purpose.

The microcomputer 110 included in the gateway 11 has the function to mediate communication carried out among the ECUs included in the vehicle 1. For example, when a first ECU 12A of the vehicle 1 needs to communicate with a second ECU 12B, the gateway 11 relays data, sent from the first ECU 12A, to the second ECU 12B. At this time, when the destination ECU is connected to a CAN bus different from the CAN bus to which the source ECU is connected, the gateway 11 sends data to an appropriate CAN bus.

In addition, the microcomputer 110 included in the gateway 11 has the function to mediate communication between an external network and the vehicle 1. For example, when the ECU 12 of the vehicle 1 needs to communicate with an external network, the gateway 11 relays data, sent from the ECU 12, to the external network. The gateway 11 also receives data, sent from an external network, and transfers the received data to an appropriate ECU 12.

In addition, the gateway 11 can perform a function unique to the gateway itself. For example, the gateway 11 has the monitoring function and the call function of the security system. Using these functions, the gateway 11 can make a security report and an emergency call based on a trigger generated in the vehicle.

The communication unit 113A is a communication interface for connecting the gateway 11 to the in-vehicle network. The communication unit 113A converts a predetermined-format message, generated by the microcomputer 110, into CAN data and converts received CAN data into a predetermined-format message for transmission to the microcomputer 110. The communication unit 113B is a communication interface for connecting the gateway 11 to an external network. The communication unit 113B converts a predetermined-format message, generated by the microcomputer 110, into communication packets and converts received communication packets into a predetermined-format message for transmission to the microcomputer 110.

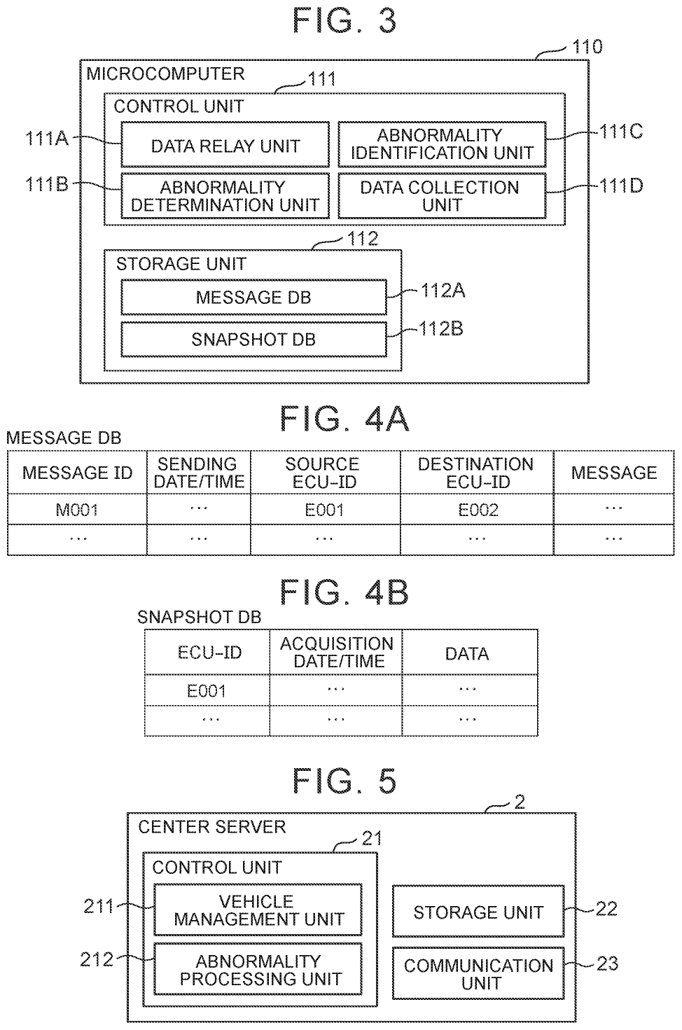

The configuration of the microcomputer 110 will be described in more detail. FIG. 3 is a diagram showing the logical configuration of the control unit 111 and the storage unit 112. The control unit 111 includes a data relay unit 111A, an abnormality determination unit 111B, an abnormality identification unit 111C, and a data collection unit 111D as the functional modules. Each functional module may also be implemented by causing the CPU to execute the corresponding program stored in the storage unit 112. The storage unit 112 stores a message DB 112A and a snapshot DB 112B.

The functional modules of the control unit 111 will be described. The data relay unit 111A receives a message that a first ECU sends to the CAN bus 13 and, as necessary, transfers the received message to a second ECU that is the destination. In addition, the data relay unit 111A stores the transferred message in the message DB 112A that will be described later. In some cases, data needs not be relayed, for example, when data is sent and received between ECUs connected to the same bus. In such a case, the data relay unit 111A only stores the message, received by the communication unit 113A, in the message DB 112A.

The abnormality determination unit 111B detects that there is an ECU that is one of the ECUs 12 of the vehicle 1 and is operating abnormally. That there is an ECU operating abnormally can be detected, for example, based on the monitoring result of the vehicle system. For example, when a message that has a sending/receiving sequence or cycle not following the specified procedure is detected in the in-vehicle network or when an ECU that should not be started is consuming power is detected, it is suspected that there is an ECU operating abnormally.

The abnormality identification unit 111C identifies an ECU that is one of the ECUs 12 of the vehicle 1 and is operating abnormally. An ECU operating abnormally can be identified based on the history of a plurality of messages stored in the message DB 112A. The abnormality identification unit 111C identifies an ECU operating abnormally, for example, by checking backward in time whether the messages stored in the message DB 112A (that is, the messages sent/received in the past) conform to the specified procedure. For example, it can be determined that an ECU that has sent a message not conforming to the specified procedure or an ECU that has communicated with an ECU that has received a message not conforming to the specified procedure is causing an abnormal operation.

The data collection unit 111D acquires snapshot data on an ECU when the ECU is identified by the abnormality identification unit 111C as an ECU causing an abnormal operation. The snapshot data, typically a memory dump of an ECU, may include other data. The acquired snapshot data is stored in the snapshot DB 112B that will be described later.

Next, the data stored in the storage unit 112 will be described. The storage unit 112 stores the message DB 112A and the snapshot DB 112B. The message DB 112A is a database that stores the history (message log) of messages sent and received by the ECUs. FIG. 4A shows an example of data stored in the message DB 112A. As shown in the figure, the message DB 112A stores the ID that uniquely identifies a message, the sending date and time of the message, the identifier of the source ECU, the identifier of the destination ECU, and the content of the message. Although the message content itself is stored in the configuration in this example, the data stored in the message DB 112A may be the digest of the message.

The snapshot DB 112B is a database that stores snapshot data acquired by the data collection unit 111D. FIG. 4B shows an example of data stored in the snapshot DB 112B. As shown in the figure, the snapshot DB 112B stores the identifier of an ECU from which the memory dump is acquired, the acquisition date and time of the memory dump, and the acquired memory dump data (binary data). Although an example of the configuration for storing a memory dump is shown in this example, the data stored in the snapshot DB 112B may include other data.

The message DB 112A and the snapshot DB 112B are built by managing data stored in the storage device. This data management is performed by programs of the database management system (DBMS) executed by the processor. The message DB 112A and the snapshot DB 112B are, for example, a relational database.

Next, the ECUs included in the vehicle 1 will be described. Each of the ECUs 12 is an electronic control unit that controls the components of the vehicle 1. The ECUs 12 control the components of different systems such as the engine system, the electrical system, and the power train system. The ECU 12 has the function to generate pre-defined messages and to send and receive them periodically via an in-vehicle network.

The ECU 12 includes a microcomputer 120 and a communication unit 123 that is an interface for communicating with the CAN bus 13.

Like the microcomputer 110, the microcomputer 120 can be configured as a microcomputer having a processor such as a CPU or a GPU, a main storage device such as a RAM or a ROM, and an auxiliary storage device such as an EPROM, a disk drive, or a removable medium.

In this embodiment, the microcomputer 120 includes a control unit 121 and a storage unit 122. The control unit 121 is an arithmetic unit that implements various functions of the ECU 12 by executing predetermined programs. The storage unit 122 is a memory device including a main storage device and an auxiliary storage device. Since their configurations are the same as those of the control unit 111 and the storage unit 112, the detailed description thereof will be omitted.

The microcomputer 120 of the ECU 12 periodically generates a message for communicating with the microcomputer of another ECU 12, and sends and receives the generated message via the communication unit 123.

The communication unit 123 is a communication interface for connecting the ECU 12 to the in-vehicle network (CAN bus). The communication unit 123 converts a predetermined-format message, generated by the microcomputer 120, into CAN data and converts received CAN data into a predetermined-format message for transmission to the control unit 121.

The CAN bus 13 is a communication bus that constitutes an in-vehicle network that is based on the controller area network (CAN) protocol. In this example, though two CAN buses, 13A and 13B, are illustrated, the in-vehicle network may have three or more communication buses. A plurality of CAN buses is connected to each other by the gateway 11.

Next, the center server 2 will be described. The center server 2 is a server device that manages a plurality of vehicles 1. The center server 2 can wirelessly send and receive data to and from the vehicles 1.

The center server 2 can be configured by a general-purpose computer. That is, the center server 2 can be configured as a computer having a processor such as a CPU or a GPU, a main storage device such as a RAM or a ROM, and an auxiliary storage device such as an EPROM, a hard disk drive, or a removable medium. The operating system (OS), various programs, various tables, etc. are stored in the auxiliary storage device. By executing the programs stored in the auxiliary storage device, the functions, which will be described later and each of which meets a predetermined purpose, can be implemented. It should be noted that some or all of the functions may be implemented by hardware circuits such as an ASIC or an FPGA.

FIG. 5 is a block diagram schematically showing an example of the configuration of the center server 2 shown in FIG. 1. The center server 2 includes a control unit 21, a storage unit 22, and a communication unit 23.

The control unit 21 is a unit for controlling the center server 2. The control unit 21 is configured, for example, by an information processing unit such as a central processing unit (CPU) or a graphics processing unit (GPU). The control unit 21 includes a vehicle management unit 211 and an abnormality processing unit 212 as the functional modules. Each functional module may also be implemented by causing the CPU to execute a program stored in a storage unit such as a ROM.

The vehicle management unit 211 periodically communicates with the vehicle 1 (the gateway 11) under its control for collecting data about the vehicle. The data related to the vehicle includes, for example, the vehicle position information, speed information, driving operation information, and communication status on the vehicle.

The abnormality processing unit 212 instructs the vehicle 1 to take an action when an abnormality occurs in any one of the ECUs 12 of the vehicle 1. More specifically, when a message indicating that an abnormality has occurred in one of the ECUs is received from the gateway 11 (from the abnormality determination unit 111B) mounted on the vehicle 1, the abnormality processing unit 212 instructs the vehicle 1 to identify an ECU that is causing the abnormal operation (in the description below, this ECU is called an abnormal ECU). In addition, the abnormality processing unit 212 acquires snapshot data collected by the gateway 11 (by the data collection unit 111D).

The storage unit 22, a unit that stores information, is configured by a storage medium such as a RAM, a magnetic disk, a flash memory, etc. The storage unit 22 stores various programs executed by the control unit 21, data used by those programs, and the like. In addition, the storage unit 22 stores data related to the vehicle 1 (for example, the identifier of the vehicle 1 and the identification information on the gateway 11).

The communication unit 23 is an interface for connecting the center server 2 to the network. The communication unit 23 can communicate with the vehicle 1, for example, via the Internet or a mobile communication network.

Next, the processing performed by the gateway 11 will be described. The processing performed by the gateway 11 is divided roughly into the following two: (1) processing for storing messages sent and received by the ECUs (first processing) and (2) processing for detecting whether an abnormality has occurred in any of the ECUs and for taking an action for the abnormality (second processing).

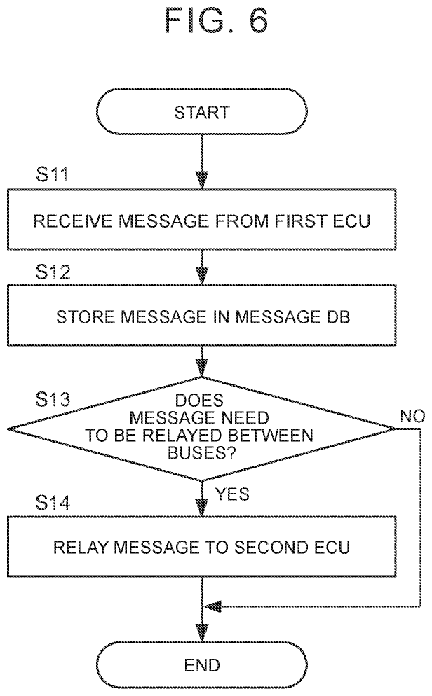

FIG. 6 is a flowchart showing the first processing. The processing shown in the figure is performed by the data relay unit 111A when an ECU included in the vehicle 1 sends and receives messages. First, in step S11, the data relay unit 111A receives a message from an ECU (first ECU) that is the source of the message. Next, in step S12, the data relay unit 111A stores the received message in the message DB 112A. Next, in step S13, the data relay unit 111A determines whether the first ECU and an ECU (second ECU) that is the destination of the message are connected to different buses and, therefore, the message needs to be relayed. When the determination in step S13 is positive, the processing proceeds to step S14 and, in step S14, the data relay unit 111A sends the received message to the bus to which the second ECU is connected. When the determination in step S13 is negative, the message needs not to be relayed and, therefore, the processing ends.

When the processing described above is performed, the messages sent and received via the in-vehicle network are stored in the message DB 112A. When the storage capacity of the storage unit 112 is insufficient, the messages may be deleted in chronological order of the timestamps.

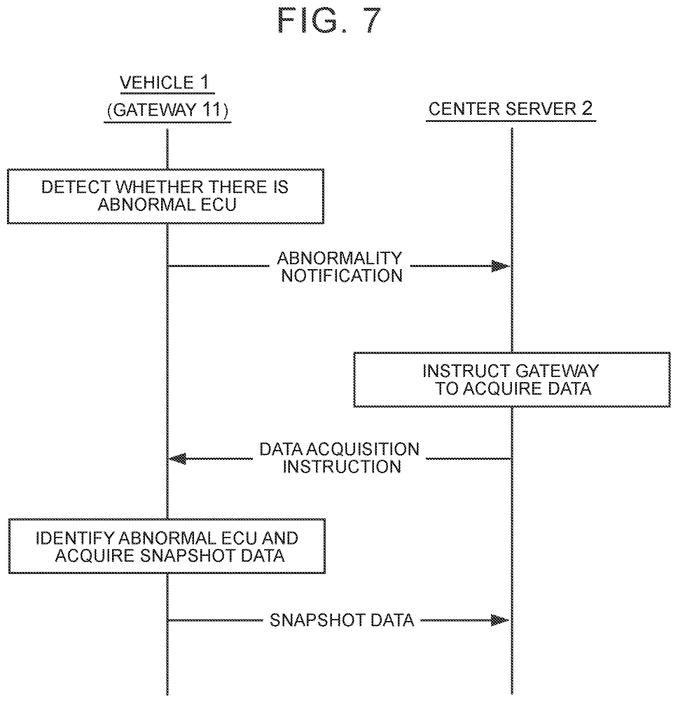

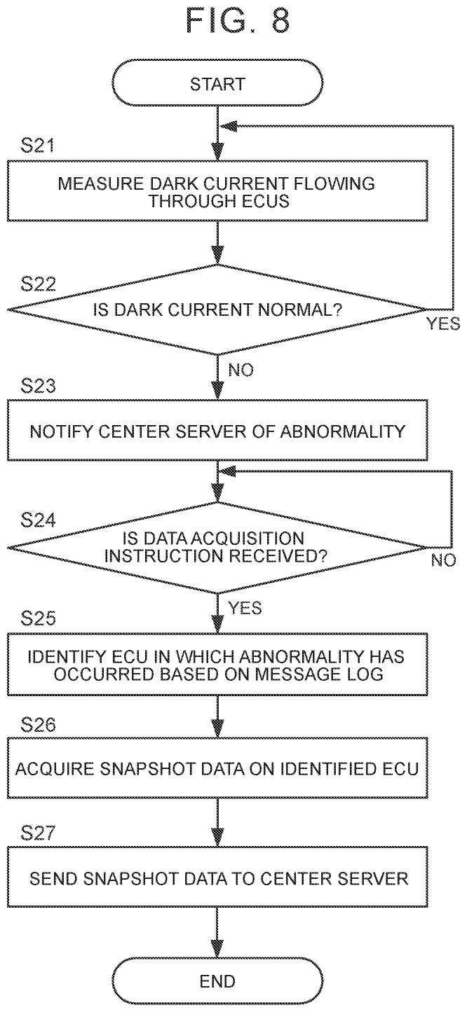

Next, the second processing will be described. The second processing is performed when an abnormality occurs in any one of the ECUs of the vehicle 1. The outline of the processing will be described first with reference to FIG. 7, followed by the detailed processing content with reference to FIG. 8.

FIG. 7 is a flowchart of data sent and received between the vehicle 1 and the center server 2. First, the gateway 11 detects whether an abnormal operation has occurred in any one of the ECUs (ECU12A, 12B, 12C . . . ) mounted on the vehicle. When it is detected that an abnormal operation has occurred in any of the ECUs, the gateway 11 sends the data (abnormality notification) to the center server 2 to indicate that an abnormal operation has occurred. When the abnormality notification is received, the center server 2 determines whether analysis is necessary. When it is determined that analysis is necessary, the center server 2 instructs the gateway 11 to acquire snapshot data. In response to this instruction, the gateway 11 identifies the ECU in which the abnormality has occurred and acquires the snapshot data. The snapshot data acquired in this way is sent to the center server 2 for use in analysis.

Next, the detail of the processing performed by the gateway 11 will be described. FIG. 8 is a flowchart of processing performed by the gateway 11. The processing shown in the figure is performed with the ignition power of the vehicle 1 turned off.

When the system power of the vehicle is turned off, the ECUs do not operate except some ECUs provided for security. However, when an ECU is attacked from the outside, there is a possibility that the ECU is operating at a time when it should not operate. In such a case, the gateway 11 in this embodiment detects that there is an ECU that is operating at a time when it should not operate and then notifies the center server of this abnormal operation. In addition, in response to an instruction from the center server, the gateway 11 identifies the ECU performing the abnormal operation and acquires snapshot data on the identified ECU. This configuration makes it possible to preserve data for investigating the cause of an abnormal operation.

Snapshot data is effective for the abnormality analysis of an ECU. However, when some abnormality has occurred in one of the ECUs, acquiring snapshot data for all the ECUs incurs unnecessary costs (analysis costs, etc.). To address this problem, when an abnormality is detected, the gateway 11 identifies the abnormal ECU based on the past message log and, then, acquires snapshot data only on the identified ECU. in this embodiment.

In steps S21 and S22, the gateway 11 determines whether there is an ECU that is operating at a time when it should not operate. First, in step S21, the abnormality determination unit 111B measures the dark current flowing through the ECUs 12. In step S22, the abnormality determination unit 111B determines whether the dark current value is within the expected range. When the dark current value is within the expected range (step S22—Yes), the processing returns to the initial state. When the dark current value is not within the expected range, the processing proceeds to step S23 (step S22—No).

When the dark current value is not within the expected range, it is presumed that one of the ECUs is performing an unexpected operation. In such a case, the abnormality determination unit 111B sends a notification (abnormality notification) to the center server 2 in step S23 to indicate that an abnormality has occurred. The abnormality notification may include other information about the host vehicle. In step S24, the abnormality determination unit 111B determines whether a data acquisition instruction is received from the center server 2. When the data acquisition instruction is received from the center server 2, the processing proceeds to step S25. When the data acquisition instruction is not received, the abnormality determination unit 111B keeps waiting for the data acquisition instruction. When a reception timeout occurs, the processing may be returned to the initial state.

In step S25, the abnormality identification unit 111C identifies an ECU that is performing an abnormal operation, based on the sending/receiving history of the messages recorded in the message DB 112A. For example, when there is a message that has a sending/receiving sequence or cycle not following the specified procedure, it can be determined that the ECU that has sent this message is operating abnormally.

In step S26, the data collection unit 111D requests the identified ECU 12 to send snapshot data and acquires the snapshot data therefrom. The snapshot data includes data on the current state of the microcomputer 120 of the ECU 12. This data is, for example, the memory dump of the main storage device, the information about the code being executed by the processor (for example, the assembly code of the program), etc. The acquired snapshot data is stored in the snapshot DB 112B and, at the same time, sent to the center server 2 (abnormality processing unit 212). In step S26, to stop the abnormal operation of the identified ECU 12, the data collection unit 111D may send a signal that resets the corresponding ECU.

As described above, when it is detected that there is an ECU (abnormal ECU) that is operating at a time when it should not operate, the gateway 11 in the first embodiment identifies the ECU that is performing abnormal operation and acquires the snapshot data on the identified ECU. This configuration makes it possible to preserve data for investigating the cause of the abnormality at an appropriate time.

### Modification of First Embodiment

In the first embodiment, when the gateway 11 detects that there is an abnormal ECU, a notification is sent to the center server 2 and, in response to an instruction from the center server 2, the acquisition of snapshot data is started. Instead of this, the acquisition of snapshot data may be started in response to an instruction from the user. For example, when the center server 2 receives an abnormality notification, a notification is sent to the terminal of the user (user terminal) and, when the user responds to this notification (for example, when the user responds to resolve the abnormality), the acquisition of snapshot data may be started.

In the first embodiment, whether there is an abnormal ECU is detected based on the dark current value measured while the system is stopped and, when there is an abnormal ECU, the identification of the abnormal ECU is started. Instead of this, the identification of an abnormal ECU may be started based on some other trigger. For example, whether there is an abnormal ECU may be detected while the vehicle is travelling. For example, when an abnormality is found in the data flowing through the in-vehicle network, the user may be notified by a warning light or the like. In this case, the user who confirms this warning light may instruct the gateway 11, via the user terminal, to acquire snapshot data. In this way, an instruction to acquire snapshot data may be issued not via the center server 2. In addition to this, the identification of an abnormal ECU may be started when some event that cannot normally occur in the system is observed by the vehicle 1.

### Modification

The above embodiment is merely an example, and the present disclosure can be appropriately modified for implementation within a range that does not depart from the spirit. For example, the processing and the units described in present disclosure can be freely combined for implementation as long as there is no technical contradiction.

Although illustrated as an in-vehicle network in the description of the embodiment, the CAN network may be any other type of in-vehicle networks such as Ethernet.

The processing described as being performed by one device may be divided for execution by a plurality of devices. Conversely, the processing described as being performed by different devices may be performed by one device. In the computer system, it is possible to flexibly change the hardware configuration (server configuration) for implementing each function.

The present disclosure can also be implemented by supplying a computer program, which implements the functions described in the above embodiments, to a computer so that one or more processors of the computer can read and execute the program. Such a computer program may be provided to the computer by a non-transitory computer-readable storage medium that can be connected to the system bus of the computer or may be provided to the computer via a network. The non-transitory computer-readable storage medium includes any type of disk, such as a magnetic disk (floppy (registered trademark) disk, hard disk drive (HDD), etc.) and an optical disc (CD-ROM, DVD disc, Blu-ray disc, etc.), and any type of medium suitable for storing electronic instructions such as a read only memory (ROM), a random access memory (RAM), an EPROM, an EEPROM, a magnetic card, a flash memory, and an optical card.

What is claimed is:

1. An information processing device that communicates with one or more electronic control units of a vehicle, the information processing device comprising a control unit configured to:
identify an electronic control unit performing an abnormal operation, based on messages sent or received by the one or more electronic control units; and
acquire snapshot data representing a current operating state of the identified electronic control unit.

2. The information processing device according to claim 1, the information processing device further comprising a storage unit configured to store messages sent or received by the one or more electronic control units in the past.

3. The information processing device according to claim 2, wherein the control unit is configured to identify the electronic control unit performing the abnormal operation based on the stored messages.

4. The information processing device according to claim 2, wherein the control unit is configured to relay messages exchanged by two or more of the electronic control units and to store the relayed messages.

5. The information processing device according to claim 1, wherein the control unit is configured to acquire a memory dump of the identified electronic control unit as the snapshot data.

6. The information processing device according to claim 1, wherein the control unit is configured to start identifying the electronic control unit performing the abnormal operation when it is detected that an abnormality has occurred in any one of the one or more electronic control units.

7. The information processing device according to claim 6, wherein the control unit is configured to notify a user when it is detected that an abnormality has occurred in any one of the one or more electronic control units and, based on an instruction from the user, to start identifying the electronic control unit performing the abnormal operation.

8. The information processing device according to claim 6, wherein the control unit is configured to detect that an abnormality has occurred in one of the one or more electronic control units based on a dark current flowing through the one or more electronic control units.

9. The information processing device according to claim 1, wherein the control unit is configured to send the acquired snapshot data to a server device that manages the vehicle.

10. The information processing device according to claim 1, wherein the control unit is configured to send a reset signal to the one or more electronic control units after acquiring the snapshot data.

11. An information processing method performed by an information processing device that communicates with one or more electronic control units of a vehicle, the information processing method comprising:
identifying an electronic control unit performing an abnormal operation, based on messages sent or received by the one or more electronic control units; and
acquiring snapshot data representing a current operating state of the identified electronic control unit.

12. The information processing method according to claim 11, the information processing method further comprising storing messages sent or received by the one or more electronic control units in the past.

13. The information processing method according to claim 12, wherein the electronic control unit performing the abnormal operation is identified based on the stored messages.

14. The information processing method according to claim 12, the information processing method further comprising relaying messages exchanged by two or more of the electronic control units and storing the relayed messages.

15. The information processing method according to claim 11, the information processing method further comprising acquiring a memory dump of the identified electronic control unit as the snapshot data.

16. The information processing method according to claim 11, wherein identifying the electronic control unit performing the abnormal operation is started when it is detected that an abnormality has occurred in any one of the one or more electronic control units.

17. The information processing method according to claim 16, the information processing method further comprising detecting that an abnormality has occurred in one of the one or more electronic control units based on a dark current flowing through the one or more electronic control units.

18. The information processing method according to claim 11, the information processing method further comprising sending the acquired snapshot data to a server device that manages the vehicle.

19. The information processing method according to claim 11, the information processing method further comprising sending a reset signal to the one or more electronic control units after acquiring the snapshot data.

20. A program causing a computer to execute the information processing method according to claim 11.
